(19) United States
(12) Patent Application Publication
(10) Pub. No.: US 2001/0031592 A1
(43) Pub. Date: Oct. 18, 2001

(54) Wning cloth and process for producing same

(76) Inventor: Wolfgang Schulz, Steinfurt (Borghorst) (DE)

Correspondence Address: BROWDY AND NEIMARK, P.L.L.C., 624 NINTH STREET, NW, SUITE 300, WASHINGTON, DC, 20001-5303, US

(21) Appl. No.: 09/826,370

(22) Filed: Apr. 5, 2001

(30) Foreign Application Priority Data
Apr. 14, 2000 (DE) 100 18 485.5

(51) Int. Cl. D03D 13/00; D03D 15/00; D03D 25/00; B32B 23/02

(52) U.S. Cl. 442/203; 428/192; 442/181; 442/217

(57) ABSTRACT

In an awning cloth comprising a plurality of webs of awning cloth that are joined along their longitudinal outer edges, wherein each web of awning cloth is formed by warp threads and weft threads of synthetic or natural filament yarns, provision is made for the webs of awning cloth to have warp threads of thermoplastic material in the region of their longitudinal outer edges, and for the overlapping edge regions of adjacent webs of awning cloth of this type to be welded to one another using said thermoplastic warp threads under at least partial melting of the same.

### BACKGROUND OF THE INVENTION

1. Field of the Invention

The present invention is directed to an awning cloth comprising a plurality of webs of awning cloth that are joined along their longitudinal outer edges and a process for producing such an awning cloth.

2. Background Art

Awning cloths are customarily produced from webs of fabric 120 cm wide. This is done by placing two adjoining webs of fabric over one another in their edge regions and, as a rule, joining them with a double seam.

This known method has the advantage of a high productivity, however, it has the shortcoming that the effective thickness of the web of fabric doubles in the seam region, causing the winding diameter on the cloth winding shaft to be enlarged in these regions in the wound up awning cloth. This results in a so-called christmas-tree effect because, due to different winding paths, folds accumulate in the cloth in the region of the seams and in the regions of the seamless webs of fabric between them.

A method is known from DE 196 02 575, according to which the weft threads that project freely in the region of the longitudinal outer edges of adjacent webs of awning fabric are interlocked and then glued together so that a joining of webs of awning fabric is accomplished without a significant increase in thickness in the region of the joint. However, this known method entails a complex production process if the fabric quality is not to be weakened concerning water repellency and resistance to tearing in the region of the final seam.

### SUMMARY OF THE INVENTION

Based on the above as a starting point, the invention is based on the object of creating an awning cloth of the above type in which the webs of cloth are joined on one hand without significantly increasing the overall thickness of the cloth, and on the other hand without impacting the fabric quality in the region of the joint.

This object is met according to the invention in such a way that the webs of awning cloth have warp threads of thermoplastic material in the region of their longitudinal outer edges and that the overlapping edge regions of adjacent webs of awning cloth of this type are welded together using these thermoplastic warp threads under partial melting of the same.

Accordingly, this object is also solved with a process in which warp threads of thermoplastic material are woven into the region of the longitudinal outer edges during production of the webs of cloth, and these edge regions are placed over one another and welded to join the webs of material.

The welding may take place in a manner known per se with a high-frequency unit, a heated wedge with a press wheel, etc.

The result is a joint that has the same thickness as the webs of woven cloth and consists of the ends of the weft threads embedded into the thermoplastic material of the warp threads. The thermoplastic material enters into the hollow spaces of the surrounding fabric, due to the welding pressure, resulting in a further anchoring in the region of the joint.

The invention will be explained in further detail below, based on a preferred embodiment in combination with the drawing.

### BRIEF DESCRIPTION OF THE DRAWINGS

FIG. 1 shows a schematic top view of the adjacent edge regions of two webs of awning cloth that are to be joined,

FIG. 2 shows the overlap of the webs of awning cloth of FIG. 1, and

FIG. 3 shows the overlap region shown in FIG. 2 after the welding process.

### DESCRIPTION OF THE PREFERRED EMBODIMENT

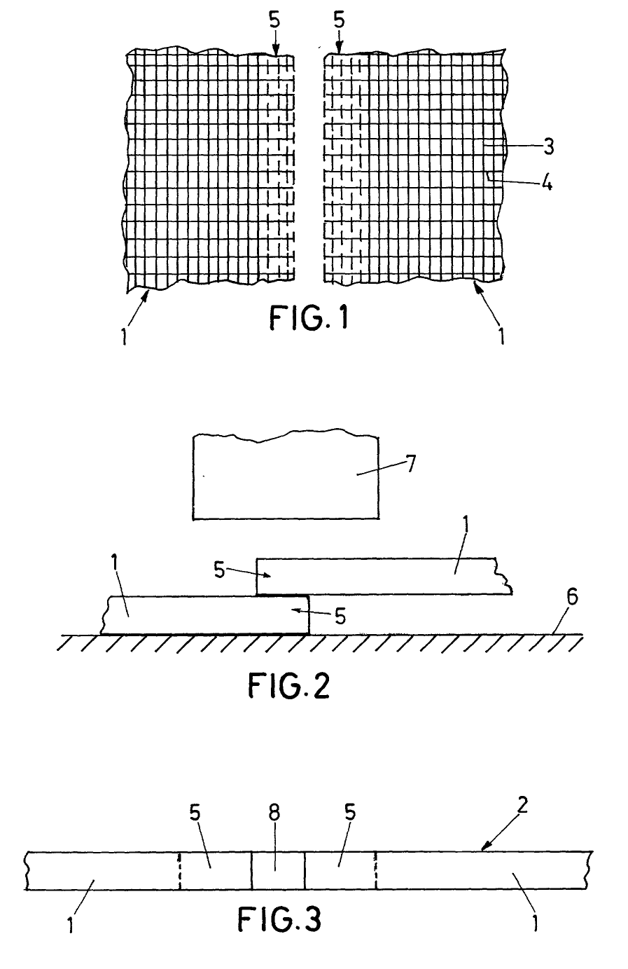

In FIG. 1, two webs of fabric 1 are shown that are to be joined, and a plurality of webs of fabric 1 of this type forms an awning cloth 2.

Each web of cloth 1 consists, in a manner known per se, of warp threads 3 and weft threads 4 extending perpendicular to one another. These threads may be composed of any synthetic or natural filament yarn.

In the edge regions 5, on the other hand, the warp threads are composed of a thermoplastic plastic, in the present embodiment of PVC.

To join the webs of cloth 1, or their edge regions 5, respectively, these edge regions 5 are placed over one another, as shown in FIG. 2, on a pad 6 and welded using a high-frequency welding unit 7, which is only shown schematically.

From this results a joint region 8, which, as shown in FIG. 3, substantially has no greater thickness than the webs of cloth 1 themselves. This joint region consists of ends of the weft threads 4 that are embedded into the thermoplastic material, and the thermoplastic material also enters into the hollow spaces of the surrounding fabric and reinforces the anchoring.

As a result, a joint is thus attained that is not bulky and, at the same time, does not weaken the properties of the material in the region of the joint 8.

What is claimed is:

1. An awning cloth comprising a plurality of webs of awning cloth that are joined along their longitudinal outer edges, wherein each web of awning cloth is formed by warp threads and weft threads of synthetic or natural filament yams, wherein the webs of awning cloth (1) have warp threads (3) of thermoplastic material in the region of their longitudinal outer edges (5), and that the overlapping edge regions (5) of adjacent webs of awning cloth (1) of this type are welded by means of these thermoplastic warp threads (3) under at least partial melting of the same.

2. An awning cloth according to claim 1, wherein the thermoplastic warp threads (3) are composed of PVC (polyvinylchloride).

3. A process for producing an awning cloth according to claim 1, wherein warp threads (3) of thermoplastic material are woven-in in the region (5) of the longitudinal outer edges during production of the webs of cloth (1) and these edge regions (5) are placed over one another and welded to join the webs of awning cloth (1).
